(19) United States
(12) Patent Application Publication
(10) Pub. No.: US 2024/0401212 A1
(43) Pub. Date: Dec. 5, 2024

(54) DIFFUSION BONDED POROUS TRANSPORT LAYERS AND FLOW FIELD PLATES FOR ELECTROCHEMICAL CELLS

(71) Applicant: ELECTRIC HYDROGEN CO., Natick, MA (US)

(72) Inventors: David EAGLESHAM, Lexington, MA (US); Nicholas HORTANCE, Marlborough, MA (US); Ruofan WANG, Natick, MA (US)

(21) Appl. No.: 18/807,496

(22) Filed: Aug. 16, 2024

Related U.S. Application Data
(63) Continuation-in-part of application No. PCT/US2023/014121, filed on Feb. 28, 2023.
(60) Provisional application No. 63/315,291, filed on Mar. 1, 2022.

(51) Int. Cl. C25B 9/23; C25B 13/02

(52) U.S. Cl. CPC C25B 9/23; C25B 13/02

(57) ABSTRACT

The following disclosure relates to electrochemical or electrolysis cells and components thereof, specifically porous transport layers within electrochemical cells and methods of making such layers. In one particular example, a method of forming a portion of an electrochemical cell includes providing a porous transport layer, placing a flow field plate adjacent to a surface of the porous transport layer, and sintering or diffusion bonding the porous transport layer and the flow field plate, therein forming a uniform or homogeneous interface between the porous transport layer and the flow field plate.

The present patent document is a continuation-in-part of PCT Application Serial No. PCT/US2023/014121, filed Feb. 28, 2023, which claims the benefit of U.S. Provisional Patent Application No. 63/315,291, filed Mar. 1, 2022, which are hereby incorporated by reference in their entireties.

### FIELD

The following disclosure relates to electrochemical or electrolysis cells and components thereof. More specifically, the following disclosure relates to electrolytic cells configured with porous transport layers (PTLs).

### BACKGROUND

Hydrogen has been considered as an ideal energy carrier to store renewable energy. Proton exchange membrane water electrolysis (PEMWE) as a means for hydrogen production offers high product purity, fast load response times, small footprints, high efficiencies, and low maintenance efforts. It is regarded as a promising technology, especially when coupled with renewable energy sources.

An electrolysis cell or system uses electrical energy to drive a chemical reaction. For example, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $10 per kilogram of hydrogen in some cases. Increases in efficiency and/or improvements in operation will continue to drive the installation of electrolyzer systems.

Porous transport layers (PTLs) may play an important role in electrochemical cells. A PTL, sandwiched between a membrane and electrode (e.g., anode) of the electrochemical cell, is responsible for transporting water and oxygen on the anode side and hydrogen on the cathode side. In addition to the role of multiphase fluid transportation, the PTL also acts as a current collector. Mass transport of PEM electrolyzers is facilitated by the PTL, an electrically conductive porous material (e.g., made of Ti) that delivers the reactant (e.g., water) to the catalyst sites, while simultaneously shedding the product (e.g., oxygen gas). The PTL's structural properties, such as mean pore diameter, bulk porosity, powder/fiber diameter, thickness, single-phase permeability, tortuosity, and porosity gradient, strongly correlate to electrolyzer performance. For example, larger pores in the PTL may be favorable for permeability but challenging for electrical/thermal conductivity. Further, it is expected that using PTLs with variations in material properties such as structure, Tortuosity, composition, thickness, and wettability results in performance changes of the PEMWE.

Therefore, there remains a desire for an improved porous transport layer for an electrochemical or electrolysis cell.

### SUMMARY

In one embodiment, a method of forming an electrolytic cell includes providing a porous transport layer; placing a flow field plate adjacent to a surface of the porous transport layer; and sintering or diffusion bonding the porous transport layer and the flow field plate, therein forming a uniform or homogeneous mixing at an interface of the porous transport layer and the flow field plate.

In another embodiment, an electrochemical cell is provided. The electrochemical cell includes a combined layer having a diffusion bonded porous transport layer and a flow field plate, wherein the combined layer comprises a uniform or homogeneous interface present between the porous transport layer and the flow field plate.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrolytic cell.

FIG. 2 depicts an additional example of an electrolytic cell.

FIG. 3 depicts an example of an arrangement of a porous transport layer having a plurality of different layers.

FIG. 4 depicts an example of a porous transport layer having a laser treated surface.

FIG. 5 depicts a top-down view an example of a porous transport layer having ablations through a thickness of the layer.

FIG. 6 depicts a top-down view of an example of a porous transport layer having all four edges laser welded.

FIG. 7 depicts an example of a tape casting method for formation of a porous transport layer.

FIG. 8 depicts an example of method for adding a catalyst to a porous transport layer composition.

FIG. 9 depicts an example of a method of sintering or diffusion bonding a porous transport layer and flow field together.

FIG. 10A is a graph depicting the benefits of implementing a diffusion-joining process in a Proton Exchange Membrane electrolyzer.

FIG. 10B depicts a cell having a non-diffusion-joined porous transport layer (PTL) and another cell having a diffusion-joined PTL.

FIG. 11 depicts an example of a porous transport layer with an ultra-porous surface.

FIG. 12 depicts an example of a porous transport layer with a three-dimensional surface.

### DETAILED DESCRIPTION

The following disclosure provides improved Porous Transport layers (PTLs) in an electrochemical or electrolytic cell for hydrogen gas and oxygen gas production through the splitting of water. Further, the following disclosure provides various processes for making the improved PTLs such as multilayer PTLs with true gradients in porosity and tailored oriented pore structures.

### Definitions

As used herein, “providing” may refer to the provision of, generation or, presentation of, or delivery of that which is provided. Providing may include making something available. For example, providing a powder may refer to a process of making the powder available, or delivering the powder, such that the powder can be used as set forth in a method described herein. As used herein, providing also may refer to measuring, weighing, transferring, combining, or formulating.

As used herein, “casting” may refer to depositing or delivering a cast solution or slurry onto a substrate. Casting may include, but is not limited to, tape casting, dip coating, and doctor blading.

As used herein, “solvent” may refer to a liquid that is suitable for dissolving or solvating a component or material described herein. For example, a solvent may include a liquid, (e.g., toluene), which is suitable for dissolving a component, (e.g., the binder), used in the garnet sintering process.

As used herein, a “binder” may refer to a material that assists in the adhesion of another material. For example, as used herein, one non-limiting binder may be polyvinyl butyral, which is useful for adhering garnet materials. Other binders may include polycarbonates and/or polymethylmethacrylates. These examples of binders are not limiting as to the entire scope of binders contemplated here but merely serve as examples. Binders useful in the present disclosure may include, but are not limited to, polypropylene (PP), atactic polypropylene (aPP), isotactic polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), PE-co-poly (methylene cyclopentane) (PE-co-PMCP), poly methyl-methacrylate (and other acrylics), acrylic, polyvinyl acetal resin, polyvinyl butyral resin (PVB), polyvinyl acetate resin, stereoblock polypropylenes, polypropylene polymethyl pentene copolymer, polyethylene oxide (PEO), PEO block copolymers, silicone, and the like.

As used herein, “green state” may refer to a composition or structure that has not undergone any subsequent heat treatment to coolest the composition into a solid or porous mass. Specifically, “green state” may refer to a composition or structure that has not been sintered. Non-limiting examples disclosed herein may refer to an unsintered fiber felt composition (e.g., unsintered titanium fiber felt), an unsintered composition or structure (e.g., unsintered titanium powder), or combinations thereof.

As used herein, “sintered state” may refer to a sintered composition or structure, such as a sintered fiber felt (e.g., sintered titanium felt), sintered structure (e.g., titanium powder that has been sintered into a solid or porous mass), or combinations thereof.

As used herein, “sintering” may refer to heating a starting composition (e.g., a powdered material or fiber felt) to coalesce the starting composition into a solid or porous mass without liquefaction, (e.g., heating the starting composition to a temperature below the melting point of a compound within the starting composition-such as a temperature below the melting point of titanium).

As used herein, a “thickness” by which is film is characterized refers to the distance, or median measured distance, between the top and bottom faces of a film in a direction perpendicular to the plane of the film layer. As used herein, the top and bottom faces of a film refer to the sides of the film extending in a parallel direction of the plane of the film having the largest surface area.

As used herein, a “Ti fiber felt structure” may refer to a structure created from microporous Ti fibers. The Ti fiber felt structure may be sintered together by fusing some of the fibers together. Ti fiber felt may be made by a special laying process and a special ultra-high temperature vacuum sintering process. The Ti fiber felt may have an excellent three-dimensional network, porous structure, high porosity, large surface area, uniform pore size distribution, special pressure, and corrosion resistance, and may be rolled and processed. However, in certain instances, Ti fiber felt may have poor mass transport properties when compressed.

As used herein, a “sintered Ti structure” may refer to a structure created by Ti powder which is pressed together using binding under high pressure. Metal injection molding (MIM), otherwise known as powder injection molding, is a well-established and cost-effective method of fabricating small-to-moderate size metal components in large quantities. It is derived from the method plastic injection molding, whereby mixing of a metal powder with a polymer binder forms the feedstock, which is then injected into a mold, after which the binder is removed via heat treatment under vacuum before final sintering. With Ti metal powder, however, the binders used in MIM results in the introduction of carbon into the matrix due to insufficient binder removal prior to sintering and/or deleterious reactions between the decomposing binder, debinding atmosphere, and the metal phase. Sintered Ti may be more rigid and may not compress as well as Ti fiber felt. The electrical conductibility of sintered Ti may not be as good as Ti fiber felt. However, sintered Ti can be very smooth, which may be advantageous for electrochemical cells with thinner membranes.

As used herein, a “perforated Ti sheet structure” may refer to a structure created from Ti sheets with perforated holes. The holes may be created or drilled by lasers. Each of the holes may be 25-100 microns in diameter extruding through the thickness of the sheet.

As used herein, “laser treatment” may refer to treating a material by utilizing a laser to melt or etch a localized area or surface of a material or ablate the material creating one or more holes through the thickness of the material.

### Electrochemical Cells

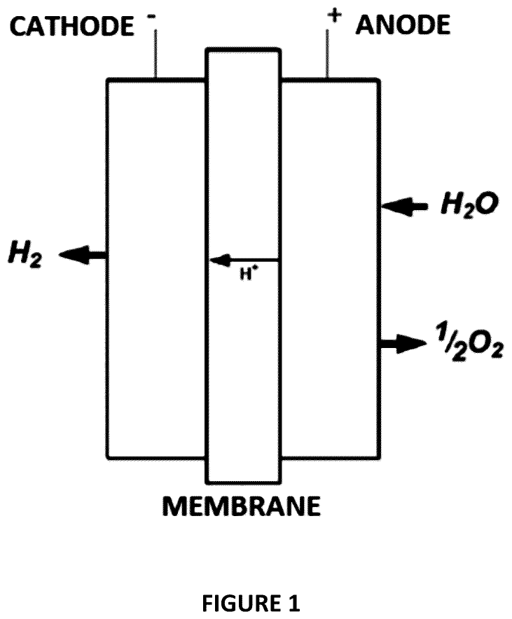

FIG. 1 depicts an example of an electrochemical or electrolytic cell for hydrogen gas and oxygen gas production through the splitting of water. The electrolytic cell includes a cathode, an anode, and a membrane positioned between the cathode and anode. The membrane may be a proton exchange membrane (PEM). Proton Exchange Membrane (PEM) electrolysis involves the use of a solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂. The water electrolysis reaction has recently assumed great importance and renewed attention as a potential foundation for a decarbonized “hydrogen economy.” Other types of electrolyzers may be used as well.

Since the performance of a single electrolytic cell may not be adequate for many use cases, multiple cells may be placed together to form a “stack” of cells, which may be referred to as an electrolyzer stack, electrolytic stack, electrochemical stack, or simply just a stack. In certain examples, a stack may contain 50-1000 cells, 50-100 cells, 500-700 cells, or more than 1000 cells. Any number of cells may make up an electrochemical stack.

The electrochemical cells within the electrochemical stack may be configured to operate with 200 mV or less of pure resistive loss when operating at a high current density (e.g., at least 3 Amp/cm² at least 4 Amps/cm², at least 5 Amps/cm², at least 6 Amps/cm², at least 7 Amps/cm², at least 8 Amps/cm², at least 9 Amps/cm², at least 10 Amps/cm², or at least 11 Amps/cm², at least 12 Amps/cm², at least 13 Amps/cm², at least 14 Amps/cm², at least 15 Amps/cm², at least 16 Amps/cm², at least 17 Amps/cm², at least 18 Amps/cm², at least 19 Amps/cm², at least 20 Amps/cm², at least 25 Amps/cm², at least 30 Amps/cm², in a range of 1-30 Amps/cm², in a range of 3-30 Amps/cm², in a range of 3-20 Amps/cm², in a range of 3-15 Amps/cm², in a range of 3-10 Amps/cm², or in a range of 10-20 Amps/cm²). In additional examples, the amount of water (e.g., deionized (DI) water) transferred to or circulated through each cell of the stack may be in a range of 0.25-1 mL/Amp/cell/min, in a range of 0.25-5 mL/Amp/cell/min, or in a range of 0.5-1 mL/Amp/cell/min.

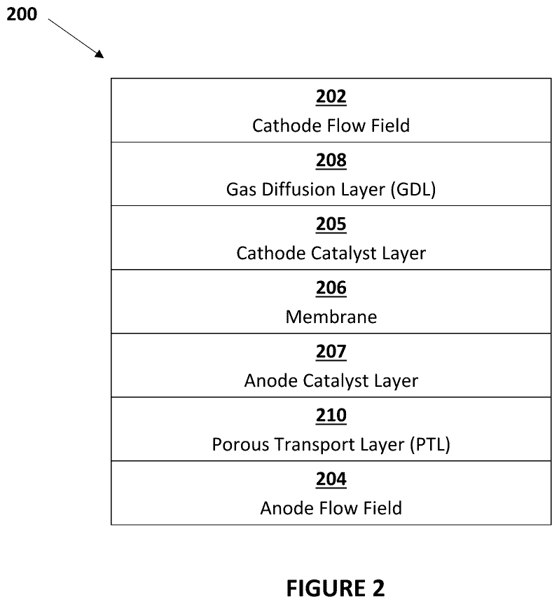

FIG. 2 depicts an additional example of an electrochemical or electrolytic cell. Specifically, FIG. 2 depicts a portion of an electrochemical cell 200 having a cathode flow field 202, an anode flow field 204, and a membrane 206 positioned between the cathode flow field 202 and the anode flow field 204.

In certain examples, the membrane 206 may be a catalyst coated membrane (CCM) having a cathode catalyst layer 205 and/or an anode catalyst layer 207 positioned on respective surfaces of the membrane 206. As used throughout this disclosure, the term “membrane” may refer to a catalyst coated membrane (CCM) having such catalyst layers.

In certain examples, additional layers may be present within the electrochemical cell 200. For example, one or more additional layers 208 may be positioned between the cathode flow field 202 and membrane 206. In certain examples, this may include a gas diffusion layer (GDL) 208 may be positioned between the cathode flow field 202 and membrane 206. This may be advantageous in providing a hydrogen diffusion barrier adjacent to the cathode on one side of the multi-layered membrane to mitigate hydrogen crossover to the anode side. In other words, the GDL is responsible for the transport of gaseous hydrogen to the cathode side flow field. For a wet cathode PEM operation, liquid water transport across the GDL is needed for heat removal in addition to heat removal from the anode side.

Similarly, one or more additional layers 210 may be present in the electrochemical cell between the membrane 206 and the anode 204. In certain examples, this may include a porous transport layer (PTL) positioned between the membrane 206 (e.g., the anode catalyst layer 207 of the catalyst coated membrane 206) and the anode flow field 204.

Similar to the GDL, the PTL is configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the CCM. Further, gaseous byproduct oxygen is configured to be removed from the PTL to the flow fields. In such an arrangement, liquid water functions as both reactant and coolant on the anode side of the cell.

In some examples, an anode catalyst coating layer may be positioned between the anode flow field 204 and the PTL.

The cathode flow field 202 and anode flow field 204 of the cell may individually include a flow field plate composed of metal, carbon, or a composite material having a set of channels machined, stamped, or etched into the plate to allow fluids to flow inward toward the membrane or out of the cell.

An improved electrochemical or electrolysis cell is desired with an efficient PTL. In other words, PTLs with variations in material properties such as structure, composition, thickness, and wettability result in performance changes of the PEMWE.

A problem with current existing cells is the use of poorly interconnected layers of materials in the cell or stack of cells. These layers are selected in order to make the conductor porous to both gases and liquids (e.g., the porous transport layer (PTL), gas diffusion layer (GDL), etc.).

One example of a currently existing cell or stack of cells with poorly interconnected layers of materials includes a cell having the following layers: (1) a Ti flow-plate layer (bipolar plate), (2) a Ti mesh layer, (3) a fine Ti mesh layer, (4) a Ti felt layer, (5) a catalyst coated membrane (CCM) layer, (6) a carbon felt or paper layer, (7) a carbon porous media layer, and (8) a Ti flow-plate layer. The materials in some cases may have conductivity which is anisotropic in the “wrong” direction. For example, the Ti felt including strands of Ti arranged mostly parallel to the plane of the layer and thus better at conducting parallel to the plane than perpendicular to the plane (i.e., bad at conducting electrons from the bipolar plate to the PEM membrane). In addition, in an existing best-in-class commercial proton exchange membrane (PEM), all these layers are joined together through simple mechanical pressure. For example, the Ti mesh layer is mechanically pressed up against the Ti flow-plate in order to produce an electrical connection. As a result, the electrical conductivity in a state-of-the-art cell or stack is limited not just by the conductivity of the materials (Ti) but by the junctions, which in the case of Ti—Ti junctions may be partially oxidized (Ti—TiO₂-TiO₂—Ti).

### Improved Porous Transport Layers

As disclosed herein, an improved cell stack with improved conductivity, porosity, and mass transport may be developed through an improved PTL positioned between a flow field plate and a membrane of a cell.

The porous transport layers may be comprised of multiple interconnecting layers. For example, any of the interconnecting layers comprising the porous transport layer may be either a Ti fiber felt structure, a sintered Ti structure, a perforated Ti sheet structure, and/or a composite of all the structures. The number of layers, the orientation of each layer, and the gradient structure of each layer may be modified to improve the efficiency of the PTL.

### 1. Combined PTL having titanium felt and titanium powder layers

In one embodiment, the PTL includes a combination of a Ti felt layer and a Ti powder layer. This example combines the performance advantages of both Ti felt and Ti sintered powder layers in a single structure.

In certain examples, this unique structure is created through a combination of a green state titanium felt with a green state, unsintered titanium powder layer, followed by a subsequent sintering of the combined multi-layer structure.

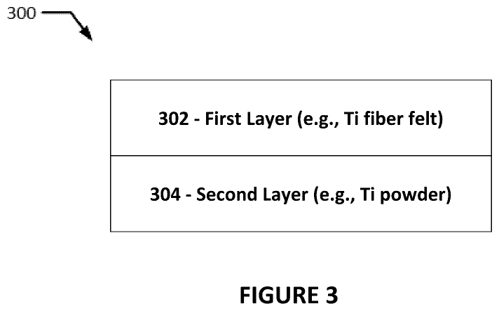

For example, as depicted in FIG. 3, the PTL 300 includes a first layer 302 and a second layer 304. The first layer 302 may be a Ti fiber felt structure and the second layer may be a Ti powder structure. In certain examples, the first layer 302 of the PTL 300 is positioned adjacent or closer to the electrode/anode (e.g., adjacent to the anode flow field of the cell) and the second layer 304 is positioned adjacent or closer to the membrane of the cell.

The process of creating such a PTL 300 structure may include forming the first layer 302 of Ti felt. This may begin by creating or extruding titanium fibers (e.g., on a nanometer scale thickness). These nanometer wire fibers may be subsequently weaved together to form a porous titanium felt layer having openings between adjacent fibers. Such a three-dimensional titanium felt structure advantageously provides larger porosity than titanium powder layers, and the various patterns of woven fibers advantageously are configured to disperse and move oxygen out laterally and toward flow field channels.

Following formation of the green state titanium felt layer 302, one or more layers 304 of titanium powder may be deposited onto a surface of the titanium felt 302. These powder particles may have varying sizes in a micrometer size range. The varying sized particles advantageously allow for a more compact, higher contact resistance, less porous (<50%), smoother layer (in comparison to the titanium felt). Such a smooth layer may be positioned adjacent to the thin membrane of the cell, which, when compressed, will not subject the membrane to perforation or other types of damage like a titanium wire in a titanium felt layer may do.

Subsequent to the deposition of the layer(s) of titanium powder, the combined product may be sintered to fuse the powders and fibers together. This single sintering process of the combined green state products to each other also advantageously provides an improved conductivity in comparison to an already sintered titanium powder layer positioned onto an already sintered titanium felt layer.

The thickness of the PTL, including both the sintered Ti structure and the Ti fiber felt structure, may be in a range of 1-1000 microns, 1-100 microns, 10-100 microns, 10-50 microns, and so on. Further, as shown in FIG. 3, the ratio of the sintered Ti structure and the Ti fiber felt structure may be 1:1, wherein 50% of the PTL is composed of the sintered Ti structure and the remaining 50% of the PTL is composed of the Ti fiber felt structure (as defined by the thickness of the structure). However, the ratio may be independently adjusted so that one layer has a greater thickness than the other. For example, the ratio may be in a range of 1:10 sintered Ti: Ti fiber felt to 10:1 sintered Ti: Ti fiber felt, in a range of 1:5 sintered Ti: Ti fiber felt to 5:1 sintered Ti: Ti fiber felt, or in a range of 1:2 sintered Ti: Ti fiber felt to 2:1 sintered Ti: Ti fiber felt. The ratio of the two layers may be configured based on desired mass transport properties, contact resistance, smoothness, etc.

### 2. Laser Treated PTL

In certain examples, one or more surfaces of the PTL may be laser treated to advantageously increase the PTL's performance within the cell during the electrochemical water-splitting reaction process. In such a laser treatment, a surface or selective area of a surface of the PTL is exposed to a laser or electron beam, which melts or etches the surface or localized area of the surface.

Such laser treatment (e.g., etching or melting) of the PTL may advantageously remove certain defects from a surface of the PTL and/or create a denser interface. The laser treatment may localize melting in a certain area, therefore creating a low resistance spot. Through the use of localized heat with the laser, the porosity at the location of the laser treatment may be modified.

Additionally, in certain examples, a surface of the Ti fiber felt structure layer may be smoothed with the use of a laser treatment or etching process to help decrease contact resistance. Ti fiber felt may not be smooth due to having woven fibers sticking out of the structure. The woven fibers create poor conductivity and may harm the surface of the membrane. However, the laser treatment process may melt or create a denser surface area on top of the Ti fiber felt structure, removing any defects or fibers.

Moreover, the laser treatment process may be used to change the surface condition of the PTL when the PTL is in its green state. By laser treating the PTL in its green state, the PTL becomes extremely smooth. For example, the PTL may be laser treated before the sintering process to add additional smoothness to the layers.

Alternatively, the PTL may be created with different micro-porosity. For example, either the Ti fiber felt structure, sintered Ti structure, or a composite structure of the two structures may be configured to create a different PTL with improved porosity, gradient structure, resistivity, etc.

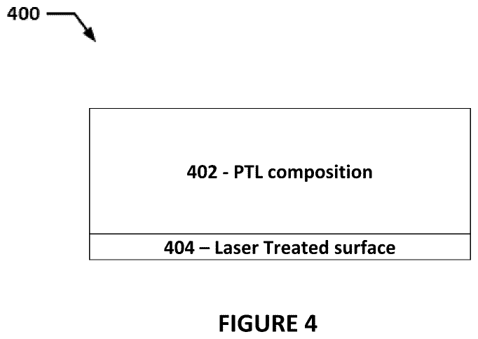

For example, as depicted in FIG. 4, the PTL 400 includes the PTL substrate 402, as known in the conventional state of the art, or in one of the advantageous compositions described herein. A surface 404 of the PTL 400 has been laser treated or etched as described herein to provide a smooth surface. This laser treated surface 404 may be posited adjacent to the membrane, advantageously providing an improved interface with the membrane.

### 3. Perforated PTL via Laser Treatment or Ablation

In another embodiment, perforations in the PTL may be made. Specifically, perforations may be made into a combined structure to create additional porosity to provide improved mass transport properties. The laser or electron beam is used to treat or ablate the PTL structure create the perforations and remove material. In some examples, the laser treatment or ablation may be applied to a conventional PTL to provide additional porosity within the conventional PTL structure. Alternatively, laser treatment/ablation may be applied to one of the unique, improved PTLs disclosed herein to provide additional porosity within the novel PTL structures within this disclosure. For example, a laser perforation may be applied to the combined titanium felt/titanium powder described herein. In certain examples, the laser ablation process may be applied to the combined Ti felt/Ti powder in the green state, before sintering. Alternatively, the laser ablation process may be carried out after the sintering of the layers takes place.

In certain examples, the laser may create porosity (e.g., 20-80%, 30-70%, or 40-60% net or effective porosity) throughout the entire PTL material or structure. The perforations may be made through a certain depth of the material less than the entire thickness of the material or through the entire thickness of the material. The use of a laser to create additional perforations into the structure advantageously allows for more control in creating porosity.

In another embodiment, the locations of the added perforations in the PTL may be configured to align with the orientation of the flow fields. For example, the perforations in the PTL may be positioned to create channels aligning with the channels of the flow field plates. Aligning the perforation to the channels of the flow field plates may be advantageous to provide O₂ removal super pathways out into the channel directly.

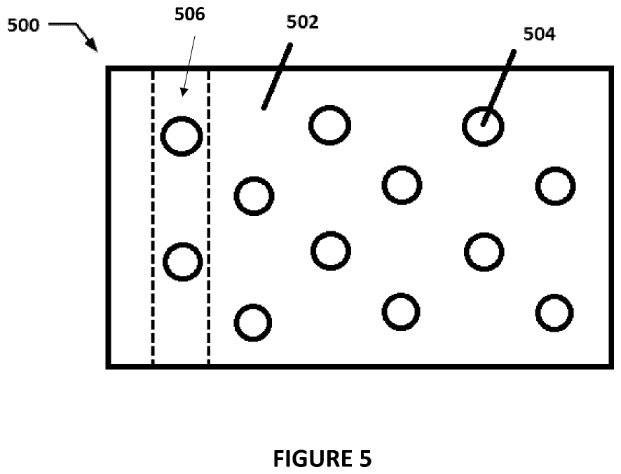

For example, FIG. 5 depicts a top-down view of a surface of a PTL layer 500. This surface may be positioned adjacent to the anode flow field or the membrane of an electrochemical cell. The PTL 500 includes the PTL substrate 502, as known in the conventional state of the art, or in one of the advantageous compositions described herein. The PTL 500 also includes a plurality of perforations 504 in the surface of the PTL substrate 502. In this particular example, the perforations 504 are ablations that extend through the entire thickness of the substrate. Additionally, in this particular example, at least one group of perforations/ablations 504 are aligned with a flow channel 506 of the anode flow field. That is, the perforations 504 are within the bounds of the outer edges of the flow channel 506 as represented by the dashed lines.

### 4. Laser Welding of PTL

In another embodiment, the laser treatment process may include using a laser to seal one or more of the outer edges of the PTL. In the process of forming a layer or sheet of the PTL, a larger sized material may be cut into the shape or dimensions required for the cell, wherein one or more of the outer edges of the layer may be damaged in the cutting process. In other words, as the structures are cut to the required dimensions, sharp or abrupt edges are left. By laser treating one or more of the edges following this cutting act, the laser treatment advantageously prevents water and/or O₂ from escaping in-plane and instead forces the fluids to go through-plane. Further, the laser may run around the entire permitter of the PTL's structures to fuse the edges and melt the edges so that there are no longer sharp walls that may puncture the cell membrane.

In some examples, this laser welding technique may be applied to a conventional PTL to provide an improved PTL over the conventional PTL having a damaged or sharp perimeter. Alternatively, the laser welding technique may be applied to one of the unique, improved PTLs disclosed herein to provide additional performance improvements for the novel PTL structures within this disclosure. For example, the laser welding of one or more edges (e.g., the entire perimeter) may be applied to the combined titanium felt/titanium powder described herein. In certain examples, the laser welding process may be applied to the combined Ti felt/Ti powder in the green state, before sintering. Alternatively, the laser welding process may be carried out after the sintering of the layers takes place.

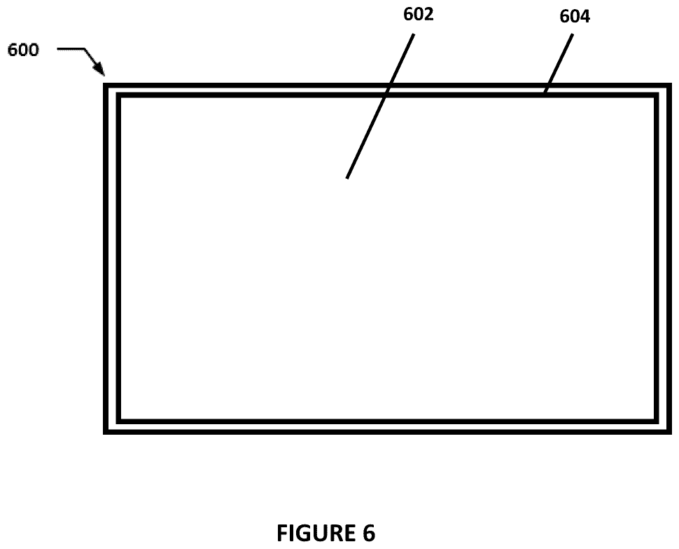

For example, FIG. 6 depicts a top-down view of a surface of a PTL layer 600. This surface may be positioned adjacent to the anode flow field or the membrane of an electrochemical cell. The PTL 600 includes the PTL substrate 600, as known in the conventional state of the art, or in one of the advantageous compositions described herein. In this example, the PTL 600 has been subjected to a laser welding technique on all four edges 604 of the substrate 602.

### 5. PTL Manufactured via Tape Casting Process

In certain examples, the PTL may be manufactured through a tape casting, a phase casting, or a freeze casting process.

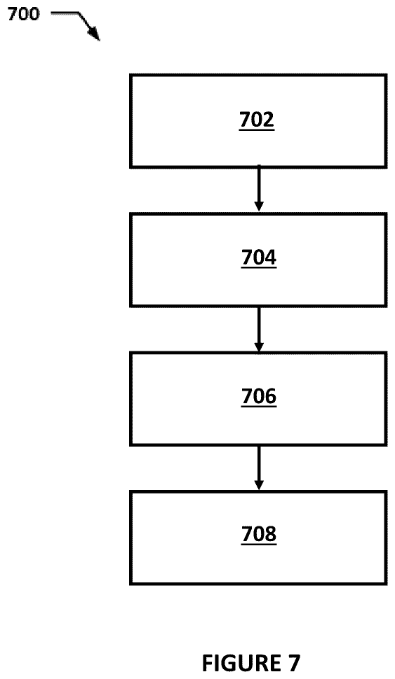

FIG. 7 depicts such an example of a tape casting process 700. The process may begin in act 702 by providing a substrate for which to support the PTL composition. The substrate may be a polymeric substrate. Alternatively, the substrate may be a perforated titanium sheet having openings within the sheet, (e.g., 10-100 micron openings or 25-50micron openings).

In act 704, the PTL composition is subsequently cast on top of a surface of the substrate. The composition may be cast in a thin extruded film layer that is subsequently dried or sintered.

In some examples, in act 706, the underlying substrate (e.g., a polymeric substrate) may subsequently be peeled or removed from the formed (and, in some cases, sintered) PTL composition.

In certain cases, in act 708, the substrate is removed from the formed and dried PTL composition and then the PTL composition is sintered (if not already done). In other alternative examples, the substrate is sintered and adhered to the PTL coating composition (e.g., wherein the substrate is a perforated titanium sheet).

The tape casting process advantageously allows the thickness and porosity of the PTL to be fine-tuned or adjusted to meet certain parameters. Specifically, the tape casting process is advantageous in optimizing the PTL's gradient structure and the pore structure's orientation. For example, the shape (e.g., cylindrical), size, and direction of the particle may be manipulated. Therefore, the process is particularly suited to manufacturing thin, porous transport layers for PEM electrolyzers.

For example, the PTL composition may include varying layers of different material compositions, advantageously allowing for greater control over the final PTL structure (e.g., the overall porosity of the structure or the gradient porosity of the structure through the varying layers). This may be achieved through the combination of a conducting material, (such as a metal composition), a binder composition, and/or a sacrificial particle composition.

One key advantage of using a powdered metal composition is that the powdered metal may settle according to size as it is deposited on the surface of the substrate, thereby allowing the porosity to be a function of the distribution of particle size. In other words, the tape casting process may allow for much more control when determining the final structure and porosity of the PTL.

In other examples, the tape casting process may allow for a specific alignment or arrangement of a PTL powder composition laid down onto the underlying substrate. For example, if the powder composition has a cylindrical shape, the powder could potentially be laid down onto the substrate in a specific alignment with the longer, longitudinal length of the cylinder extending in a perpendicular direction from the planar substrate surface.

The metal composition may additionally, or alternatively, include an oxidation-resistant metal such as, but not limited to, Pt, Au, Ti, Cr, Si, Zr, Y, Nb, and/or Al. This oxidation-resistant metal may be particularly advantageous in limiting corrosion on the anode side of the cell from the oxygen generated in the water-splitting reaction. Alternative metal compositions may include TiC, TiN, TiB₂ particles, and so on. These metals or metal composition may be advantageously included within the PTL composition to adjust/improve through-plate resistivity, porosity, contact resistance, or other electrochemical aspects of the PTL.

The binder composition may be any material configured to bind and coat the metal composition, such as a plastic or paraffin composition (e.g., polyvinyl butyral). The percentage or concentration of binder in the overall starting composition is variable (e.g., 10-90 wt. %, 20-80 wt. %, 30-70 wt. %, or 40-60 wt. %). The binder may be chosen for removal in air or vacuum at low enough temperature to not induce embrittlement of Ti from O or N uptake (e.g., 350° C.).

In certain examples, the metal composition is a metal powder composition that is mixed with the plastic or paraffin binder and heated to a temperature causing the binder to melt and mix with/coat the metal powder. This mixed composition is subsequently extruded as a sheet, deposited onto the underlying substrate, and cooled.

In certain examples, multiple layers of extruded sheets are formed with varying percentages and parameters for the metal powder and the binder composition. For instance, a first extruded layer may be formed with a 10 micron metal powder particle size and 50 wt. % binder. The second extruded layer may have a similar particle size metal powder but only 30 wt. % binder. This advantageously allows for greater control over the conductivity and porosity of the overall PTL.

In additional or alternative examples, the PTL metal powder composition may be combined with a sacrificial micrometer or nanometer sized sacrificial particle composition (e.g., polystyrene), which may subsequently be removed from the formed layer prior to sintering. This may advantageously create or enhance the porosity within the PTL.

In yet other examples, following the extrusion or deposition of a PTL powder composition (e.g., titanium powder) on top of a substrate such as a first perforated titanium metal layer, a second perforated titanium foil layer may be placed on top of the PTL powder composition to create a sandwiched PTL composition between two titanium foil layers. The second perforated titanium metal layer may have a different porosity than the first metal layer (and the internal sandwiched PTL composition), therein providing a gradient between the first and second metal layers from decreasing to increasing porosity size (or the opposite).

### 6. Embedded Catalyst in PTL

In various commercial examples, a catalyst coating layer may be placed on a surface of the membrane, adjacent to the PTL. However, as disclosed herein, the catalyst may be embedded into the PTL during the formation of the PTL.

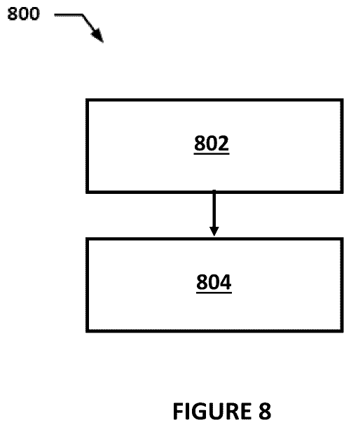

For example, FIG. 8 depicts such an example of a catalyst addition process 800 to a PTL composition. In act 802 of the method 800, catalyst particles (e.g., platinum, iridium, iridium oxide, and so on) may be embedded into various pores within a titanium powder structure, thereby functionalizing the sintered porous Ti to reduce through plate resistivity, improve porosity, improve contact resistance, and provide other electrochemical improvements.

By embedding the catalyst into the porosity of the Ti powder structure, the surface area is increased, and improved performance is provided. Further, the embedded catalyst is locked into the metallic lock within the matrix of the titanium powder structure. Additionally, the catalyst is advantageously not destroyed during the sintering process of the titanium powder. This also may advantageously improve the length of catalyst life within the cell.

In some examples, this catalyst addition technique to the PTL may be applied to the additionally mentioned embodiments disclosed within this document.

For example, in act 802, the catalyst may be added to a green-state titanium fiber felt or green-state titanium powder layer prior to sintering of the combined titanium compositions. In act 804, the combined catalyst and PTL composition may subsequently be sintered.

Alternatively, this catalyst addition technique to the PTL may be applied to conventional PTL structures, such as a single layer Ti felt composition, prior to the sintering of the Ti felt composition.

### 7. Formation of Combined PTL and Flow Field Plate

In certain examples, the entire composite structure or even a single structure of the PTL is positioned on the flow field plate of the cell. The composite structure having both the flow field plate and the PTL composition are sintered together or diffusion bonded together to provide an improved interface between the PTL and anode flow field. In certain examples, the PTL is provided in its green-state when positioned on the flow field plate of the cell, and subsequently sintered or diffusion bonded together. Alternatively, the PTL may be provided in its sintered state when positioned against a surface of the flow field plate of the cell, and subsequently diffusion bonded together as described in the process below.

This process may be advantageous in providing an improved product with less contact resistance between the flow field and PTL. This can advantageously reduce or minimize the potential area for oxidation or corrosion to occur. Further, a smaller amount of accessible area for corrosion may potentially improve the durability of the cell because the cell will corrode at a slower rate. Additionally, the process of sintering or diffusion bonding the flow field and PTL together may reduce the need for any anti-corrosion coating on the surface of the flow field facing the PTL and/or the surface of the PTL facing the flow field. This may advantageously lead to a decrease in manufacturing time and cost associated with application of the anti-corrosion coating.

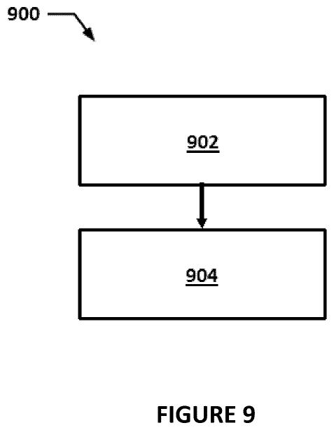

FIG. 9 depicts a non-limiting example of such a process 900 of forming a combined PTL and flow field. In act 902 of the method 900, a PTL structure is positioned on a surface of the flow field having channels and lands (i.e., active area of the flow field). The PTL structure may be a conventional PTL known in the art. Alternatively, the PTL may be one of the improved PTL composition formulations discussed herein. In certain examples, the PTL structure may be a green-state or unsintered PTL structure. For example, the PTL may include a green-state Ti fiber felt and/or a green-state Ti powder. Alternatively, the PTL structure may be a sintered PTL structure, e.g., a sintered Ti fiber felt and/or a sintered Ti powder. Such a PTL structure may be positioned adjacent to the anode flow field.

Subsequently, in act 904 of the method 900, the PTL and anode flow field may collectively be sintered or diffusion bonded together to provide both an improved PTL composition (as discussed above) as well as an improved PTL/flow field interface.

For example, an uncoated flow field is utilized and the PTL (e.g., green-state PTL) is provided on top of the active area of the uncoated flow field. Next, the combined PTL and flow field are placed into a furnace exhibiting high temperatures, low pressure, and/or noble gases for a defined period of time. The combined PTL and flow field is sandwiched between two aluminum plates inside the furnace. As a result, the metal PTL may be diffusion-joined to the metal flow field.

In certain examples, the temperature for the environment (e.g., a furnace or chamber) the sintering/diffusion bonding process may be at least 150° C., at least 300° C., at least 600° C., at least 800° C., at least 850° C., at least 900° C., at least 1000° C., at least 1100° C., at least 1200° C., in a range of 150-1200° C., in a range of 150-600° C., in a range of 600-1200° C., in a range of 800-1200° C., in a range of 850-1200° C., in a range of 900-1200° C., in a range of 1000-1200° C., in a range of 1100-1200° C., in a range of 800-1100° C., in a range of 800-1000° C., in a range of 850-1000° C., in a range of 850-950° C., in a range of 900-1100° C., or in a range of 900-1000° C.

In certain examples, the pressure of the environment (e.g., the furnace or chamber) for the sintering/diffusion bonding process may be less than 1 atm, less than 0.1atm, less than 0.01 atm, less than 0.001 atm, less than 0.0001 atm, or in a range of 0.0001-0.1atm, or in range of 0.0001-0.01 atm.

In certain examples, the atmosphere of the environment (e.g., the furnace or chamber) for the sintering/diffusion bonding process may include a noble gas composition. In certain examples, the atmosphere includes helium, neon, argon, krypton, xenon, radon, or a combination thereof. In certain particular examples, the atmosphere includes argon. The atmosphere may include at least 50 vol. % of a noble gas composition, at least 60 vol. %, at least 70 vol. %, at least 80 vol. %, at least 90 vol. %, at least 95 vol. %, at least 99 vol. %, at least 99.9 vol. %, or 100% of the noble gas composition.

In certain examples, the defined period of time for carrying out the sintering/diffusion bonding process may be at least 10 minutes, at least 30 minutes, at least 1 hour, at least 2 hours, at least 3 hours, at least 4 hours, at least 5 hours, in a range of 30minutes to 5 hours, in a range of 1 hour to 5 hours, in a range of 1 hour to 3 hours, or in a range of 1 hour to 2 hours.

This diffusion bonding process advantageously allows for a uniform or homogenous mixing of the two different layers together at the interface between the two layers. The advantageously reduces the interface contact resistance compared to how the two different layers are adhered or compressed together in the current state of the art. Through an improved (i.e., reduced) contact resistance, the electrochemical cell and stack may advantageously operate better. Specifically, current flow and distribution may be improved and corrosion in the oxygen rich environment may be reduced (in the absence of anti-corrosion layers positioned between the PTL and flow field).

In certain examples, the diffusion bonding of the PTL and flow field may form a combined, diffusion bonded layer that has an area-specific resistance of less than 5 μOhm*cm², less than 4 μOhm*cm², in a range of 3-6 μOhm*cm², in a range of 3-5 μOhm*cm², or in a range of 3-4 μOhm*cm².

In certain examples, the diffusion bonding process may be combined with one or more of the additional processes disclosed herein to provide further improvements for the PTL and adjacent layers within the electrochemical cell. For example, one or more of the laser treatment processes disclosed above may be applied to the sintered/combined PTL and flow field layers. As noted above, this laser treatment may be applied to the exposed surface of the PTL component of the combined layers to remove any defects and create a smooth PTL surface, which advantageously may reduce or eliminate damage from the PTL composition on the membrane subsequently placed adjacent to the exposed surface of the PTL component of the combined, sintered PTL/flow field.

For example, the efficiency of an electrochemical cell is enhanced by minimizing the resistances of its individual components, namely the catalyst coated membrane (CCM), gas diffusion layer (GDL), flow fields, and porous transport layer (PTL), while maintaining the structural integrity and durability. When assembled, these components create interfacial or contact resistances that impede performance.

Thus, this improved contact minimizes the area available for oxidation and corrosion, thus slowing the corrosion rate and enhancing the cell's durability. Additionally, it lessens the need for anti-corrosion coatings on the flow field and PTL, resulting in reduced time and costs associated with applying these coatings.

Initial experiments, detailed in Table 1 below, illustrate the improved contact resistance between a PTL and a flat titanium plate, representing a flow field. In these experiments, neither the PTL nor the flat titanium plate were coated with any anti-corrosion coating. Additionally, the contact resistance was determined at varying furnace temperatures (850° C., 900° C., and 950° C.) and in different furnace environments such as Argon and air. The experiments with Argon were conducted at atmospheric pressure, while those with ambient air were performed under vacuum conditions. It is worth noting that while only Argon was used in this study, other noble gases that do not react with Titanium metal could potentially yield similar results.

TABLE 1
Area-Specific Resistance (μOhm*cm²)
(No Anti-Corrosion Coating Layers Applied)

| Individual Samples | | PTL Diffusion-Joined to Flat Ti Plate | | | | |
|---|---|---|---|---|---|---|
| (No Diffusion-Joining) | | Furnace Temperature | | 850° C. | 900° C. | 950° C. |
| Flat Ti | 3.03 +/− | Furnace | Argon | — | 3.79 +/− | 5.81 +/− |
| Plate | 0.12 | Environment | | | 0.22 | 0.67 |
| PTL on | 6.08 +/− | | Vacuum | 4.64 +/− | 8.08 +/− | — |
| top of | 0.36 | | | 0.43 | 0.77 | |
| Flat Ti | | | | | | |
| Plate | | | | | | |

Referencing Table 1 above, the table presents area-specific resistance measurements (in μOhmcm²) for different configurations of a PTL and a flat titanium plate, used as a flow field, without any anti-corrosion coatings applied. Initially, the flat titanium plate exhibits a lower resistance of 3.03±0.12 μOhm*cm2 compared to 6.08 +0.36Ohm+cm2 when the PTL is placed atop it. Through diffusion-joining processes conducted at varying furnace temperatures (e.g., 850° C., 900° C., and 950° C.), significant reductions in resistance are observed.

For instance, at 900° C. in an argon environment, the resistance decreases to 3.79 +0.22 μOhm*cm², indicating improved contact between the PTL and titanium plate. Further, as the temperature increases to 950° C., conducted under Argon, the table shows a resistance level of 5.81±0.67 μOhm*cm². Alternatively, resistance levels at temperatures of 850° C. and 900° C., conducted under vacuum, showed resistance values of 4.64±0.43 μOhm*cm² and 8.08±0.77 μOhm*cm², respectively.

Under normal conditions (i.e., currently known cell formation conditions without diffusion bonding), the contact resistance measured 6.08±0.36 μOhm*cm². However, when the PTL was diffusion-joined to the flat titanium plate, the contact resistance dropped to 3.79±0.22 Ohm*cm². This improved contact not only enhanced current flow but also reduced the area susceptible to corrosion in the absence of anti-corrosion layers.

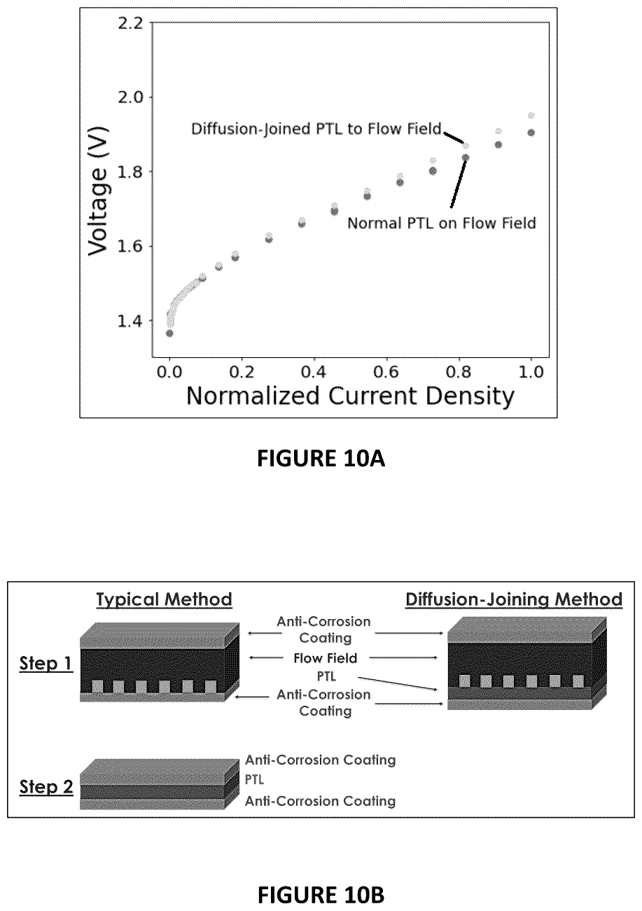

FIG. 10A is a graph depicting the benefits of implementing a diffusion-joining process in a Proton Exchange Membrane (PEM) electrolyzer, as evidenced by polarization curves. These curves are used to analyze the relationship between voltage and current density, normalized to the highest current density applied to the cell. In comparing two types of cells, one with traditional coatings (i.e., two coatings per layer for a total of four coatings for the Porous Transport Layer (PTL) and flow field) and the other utilizing diffusion-joining (reducing coatings to a total of two coatings for the PTL and flow field), the results show comparable voltage performance across most tested current densities. However, at higher current densities exceeding 0.7, the diffusion-joined cell demonstrates a slightly higher voltage of 30-50 mV. While there is an increase in voltage for the diffusion-joined process, such an increase is not detrimental given that two anti-corrosion coatings are not present. FIG. 10A also suggests additional optimization strategies such as applying external pressure during assembly and polishing the flow field for smoother integration, aiming to further minimize performance differences and enhance overall cell efficiency.

FIG. 10B depicts a comparison between two cells and an additional advance of the diffusion bonding process. For example, FIG. 10B depicts a typical method of forming an electrochemical cell. The process includes a first step in which an anti-corrosion coating is applied to both surfaces of a flow field. The typical process includes a second step in which an anti-corrosion coating is applied to both surfaces of the PTL. Subsequently, in a third step (not depicted), the flow field and PTL are placed adjacent to each other during the cell formation.

In contrast, the diffusion bonding or sintering process may advantageously eliminate the need for coating two of the four surfaces. Specifically, in this improved process, the flow field and the PTL are placed adjacent to each other, and sintered/diffusion bonded as described above. Anti-corrosion layers are added to the external, exposed surfaces of the combined flow field/PTL. As such, no anti-corrosion layer is added to the flow field surface positioned adjacent to the PTL. Similarly, no anti-corrosion layer is added to the PTL surface positioned adjacent to the flow field. This reduction in the number of anti-corrosion layers may advantageously reduce the cost and time required in the manufacturing of the cell and application of coating layers to the flow field and PTL.

### 8. Added Compositions to PTL Powder to Reduce Interface Contact Resistance

As noted above, in certain examples, the PTL composition (e.g., titanium fiber felt or powder) may additionally include a noble metal, such as platinum, gold, or silver. These metals or metal composition may be advantageously included within the PTL composition to adjust/improve through-plate resistivity, porosity, contact resistance, or other electrochemical aspects of the PTL.

Again, like other examples within this disclosure, this particular embodiment may be applied to conventional state of the art PTL compositions, as well as the improved PTL composition formulations discussed herein. In one example, a noble metal composition may be added to a green-state Ti fiber felt and/or a green-state Ti powder and subsequently, collectively sintered together to provide both an improved PTL composition (as discussed above) with the additional improved performance characteristics provided by the noble metal.

Additionally, or alternatively, the noble metal may be added to a green-state PTL composition that is additionally positioned adjacent to the anode flow field. The noble metal PTL composition and adjacent anode flow field may be subsequently collectively sintered together to provide both an improved PTL composition as well as an improved PTL/flow field interface.

### 9. Ultra-porous PTL via Direct Metal Laser Sintering

In certain examples, an ultra-porous layer may be combined or added to a surface of a PTL formed via one of the methods/processes discussed above. The ultra-porous layer may be formed via 3D printing (e.g., via direct metal laser sintering). In other words, a 3D printed ultra-porous Ti structure may be positioned or added on top of a PTL such as a Ti fiber felt structure, a sintered Ti structure, a perforated Ti sheet structure, etc. The additional 3D printed Ti powder advantageously creates a very high degree of porosity within the PTL (e.g., greater than 50%, greater than 60%, greater than 70% porosity).

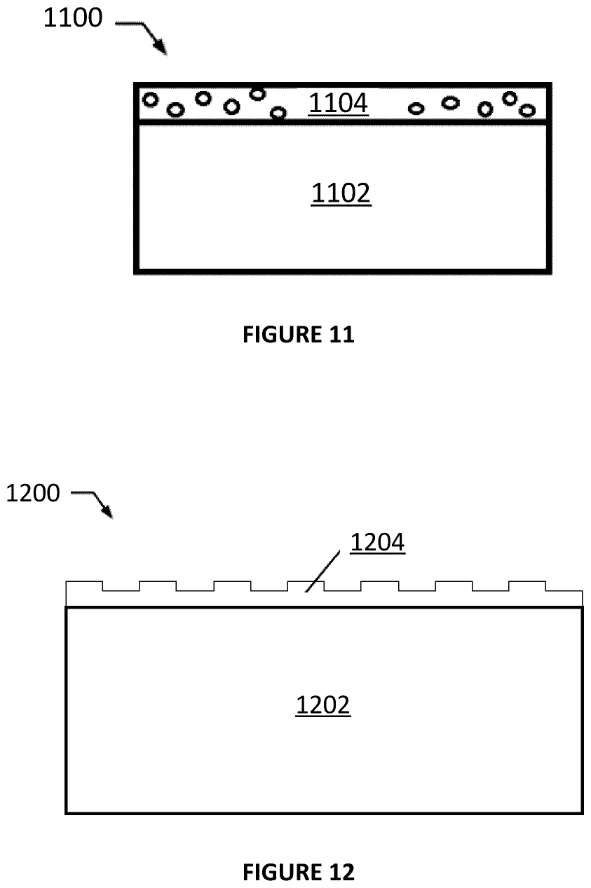

FIG. 11 depicts such an example of an improved PTL structure 1000. In this example, the PTL structure 1000 includes a PTL substrate 1002 or base layer. This base layer may be formed from a PTL composition known in the conventional state of the art. Alternatively, the base layer or substrate 1002 may include one or more of the advantageous compositions described herein. For example, the PTL substrate 1002 may include a combination of a green-state Ti fiber felt and a green-state Ti powder that are subsequently sintered together. On one surface of the substrate 1002, the PTL structure includes an ultra-porous layer 1004. As noted above, this ultra-porous layer may be added to the substrate 1002 via a 3D printing process.

### 10. Post Processing of Formed PTL

In certain cases, any of the formed PTL compositions or layers discussed in the examples above may be post-processed by electropolishing or laser treating the multiple interconnecting layers to remove any defects (e.g., to smooth out any rough or sharp surface areas).

This post-process step may be advantageous for similar reasons to laser treating a surface of the PTL. For example, the creation or smoothing out of a surface of the PTL that is configured to be positioned adjacent to the membrane may advantageously reduce or eliminate damage that the PTL may cause on the surface of the membrane (e.g., via titanium wire ends poking into the membrane after compression of the two layers together).

### 11. Creation of three-dimensional (3D) surface on PTL

In certain examples, the PTL may be formed to have a non-smooth or non-uniform surface on purpose. For example, the PTL may be formed to have a three-dimensional structure on one of the surfaces of the PTL. For example, the 3D structure may include ridges that have been etched/lasered into the PTL or deposited/3D printed onto the first surface of the PTL that is positioned adjacent to the flow field layer. These ridges may be designed or configured to align with the ridges or flow channels in the flow field layer to improve the fluid transport within the cell.

Additionally, or alternatively, a surface of the PTL may be formed to have a 3D surface designed or configured to improve the surface area characteristics of the PTL.

The second, opposite surface of the PTL configured to be positioned adjacent to the membrane may be configured to have a smooth/flat surface, as described in the various examples above.

FIG. 12 depicts such an example of an improved PTL structure 1100. In this example, the PTL structure 1100 includes a PTL substrate 1102 or base layer. This base layer may be formed from a PTL composition known in the conventional state of the art. Alternatively, the base layer or substrate 1102 may include one or more of the advantageous compositions described herein. For example, the PTL substrate 1102 may include a combination of a green-state Ti fiber felt and a green-state Ti powder that are subsequently sintered together. On one surface of the substrate 1102, the PTL structure includes a 3D surface layer 1104. As noted above, this 3D surface layer 1104 may be added or created on a surface of the substrate 1102 via etching or applying a laser to the surface of the substrate 1102 to introduce ridges.

### 12. Localized Laser Welding of PTL to Adjacent Layer

In certain examples, the PTL may be adhered to an adjacent layer of the cell (e.g., to the flow field plate) via a localized laser weld. Such laser treatment may localize melting in a certain area, therefore creating a low resistance spot. In certain examples, a ridge of the flow channel or flow plate and the adjacent surface of the PTL (e.g., such as a ridge on a 3D surface of the PTL, as described above) may be treated locally with a laser at such a temperature to physically weld the two materials to each other.

The localized laser treatment welding the PTL to the flow field plate may be combined with additional embodiments referenced in this disclosure or to the conventional state of the art. For example, a novel, improved PTL composition may be manufactured by combining a green-state Ti fiber felt layer and a green-state Ti powder layer and subsequently, collectively sintered the two layers together to provide both an improved PTL composition (as discussed above). Subsequently, the sintered PTL layer may be combined with an anode flow field, wherein the sintered PTL layer and anode flow field are adhered to each other via a localized laser weld.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A method of forming a portion of an electrochemical cell, the method comprising:
providing a porous transport layer;
placing a flow field plate adjacent to a surface of the porous transport layer; and
diffusion bonding the porous transport layer and the flow field plate, therein forming a combined layer having a uniform or homogeneous interface between the porous transport layer and the flow field plate.

2. The method of claim 1, wherein the flow field plate is an anode flow field plate of the electrochemical cell.

3. The method of claim 1, wherein the diffusion bonding of the porous transport layer and the flow field plate comprises:
heating the porous transport layer and the flow field plate inside a furnace at a temperature in a range of 800° C. to 1200° C.

4. The method of claim 3, wherein the temperature is in a range of 850° C. to 950° C.

5. The method of claim 1, wherein the diffusion bonding of the porous transport layer and the flow field plate comprises:
heating the porous transport layer and the flow field plate inside a furnace at a pressure of less than 1 atm.

6. The method of claim 5, wherein the pressure is less than 0.01 atm.

7. The method of claim 1, wherein the diffusion bonding of the porous transport layer and the flow field plate comprises:
heating the porous transport layer and the flow field plate within an environment comprising a noble gas that is unreactive with titanium metal present in the flow field plate and/or the porous transport layer.

8. The method of claim 7, wherein the noble gas is argon.

9. The method of claim 1, wherein the combined layer comprises an area-specific resistance of less than 5 μOhm*cm².

10. The method of claim 1, wherein the combined layer comprises an area-specific resistance of less than 4 μOhm*cm².

11. The method of claim 1, wherein the combined layer comprises an area-specific resistance in a range of 3-5 μOhm*cm².

12. The method of claim 1, wherein, prior to the diffusion bonding, the flow field plate comprises no anti-corrosion resistant coating positioned adjacent to the porous transport layer and the porous transport layer comprises no anti-corrosion resistant coating positioned adjacent to the flow field plate.

13. The method of claim 1, wherein the providing of the porous transport layer comprises providing an unsintered porous transport layer.

14. An electrochemical cell comprising:
a combined layer having a diffusion bonded porous transport layer and a flow field plate,
wherein the combined layer comprises a uniform or homogeneous interface present between the porous transport layer and the flow field plate.

15. The electrochemical cell of claim 14, wherein the combined layer comprises an area-specific resistance of less than 5 μOhm*cm².

16. The electrochemical cell of claim 14, wherein the combined layer comprises an area-specific resistance of less than 4 μOhm*cm².

17. The electrochemical cell of claim 14, wherein the combined layer comprises an area-specific resistance in a range of 3-5 μOhm*cm².

18. The electrochemical cell of claim 14, wherein the electrochemical cell comprises no anti-corrosion resistant coating positioned on a surface of the porous transport layer that is adjacent to the flow field plate, and
wherein the electrochemical cell comprises no anti-corrosion resistant coating positioned on a surface of the flow field plate that is adjacent to the porous transport layer.

19. The electrochemical cell of claim 14, wherein the flow field plate is an anode flow field plate of the electrochemical cell.
